(19) United States
(12) Patent Application Publication
(10) Pub. No.: US 2026/0219629 A1
(43) Pub. Date: Jul. 30, 2026

(54) JOINT STRUCTURE, IMAGE FORMING APPARATUS, AND JOINING METHOD

(71) Applicant: Fujifilm Business Innovation Corp., Tokyo (JP)

(72) Inventor: Hiroyuki KONO, Kanagawa (JP)

(73) Assignee: Fujifilm Business Innovation Corp., Tokyo (JP)

(21) Appl. No.: 19/307,780

(22) Filed: Aug. 22, 2025

(30) Foreign Application Priority Data
Jan. 27, 2025 (JP) 2025-01166

(51) Int. Cl. G03G 21/16; B23K 26/244; B23K 101/24

(52) U.S. Cl. CPC G03G 21/1619; B23K 26/244; G03G 21/1647; B23K 2101/24; G03G 2221/1678

(57) ABSTRACT

A joint structure includes: a first member including a first sheet-shaped part; a second member including a second sheet-shaped part overlapped with the first sheet-shaped part in a sheet thickness direction of the first sheet-shaped part and the second sheet-shaped part; a restriction part provided for the first member, the restriction part being in contact with the second member from an opposite side from the first sheet-shaped part side relative to the second sheet-shaped part in the sheet thickness direction, the restriction part restricting the second sheet-shaped part from moving away from the first sheet-shaped part in the sheet thickness direction; and a welding portion that is provided in a predetermined range from the restriction part and at which the first member and the second member are welded.

### CROSS-REFERENCE TO RELATED APPLICATIONS

This application is based on and claims priority under 35 USC 119 from Japanese Patent Application No. 2025-011666 filed January 27 2025.

### BACKGROUND

### i Technical Field

The present disclosure relates to a joint structure, an image forming apparatus, and a joining method.

### ii Related Art

For example, Japanese Unexamined Patent Application Publication No. 2005-297026 discloses a laser welding method in which metal sheet materials including at least steel sheet with zinc-based plating are overlapped and welded, and also discloses metal sheet materials and a welded structural body used for the laser welding method. In the laser welding method, a section of at least one metal sheet material perpendicular to a weld line has a crank shape having a recess on the mating surface side. In the laser welding method, when a minimum depth of the recess on the weld line is Xa (mm), a maximum depth of the recess on the weld line is Xb (mm), a sheet thickness of the thinner metal sheet is Ya (mm), a sheet thickness of the metal sheet on the irradiation surface side is Yb (mm), and a total adhesion amount of zinc on surfaces overlapped onto each other is Z (g/m²),

Xa ≥ Z/(4800 × Ya)

Xb ≤ 0.35 × Yb

are established, and a bending in the vicinity of the crank shape has an angle so as to protrude on the mating surface side.

### SUMMARY

Aspects of non-limiting embodiments of the present disclosure relate to providing a joint structure, an image forming apparatus, and a joining method that facilitate a process in manufacturing when multiple members are joined by welding, compared with a case where joint is achieved with only a welding portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a joint structure including: a first member including a first sheet-shaped part; a second member including a second sheet-shaped part overlapped with the first sheet-shaped part in a sheet thickness direction of the first sheet-shaped part and the second sheet-shaped part; a restriction part provided for the first member, the restriction part being in contact with the second member from an opposite side from the first sheet-shaped part side relative to the second sheet-shaped part in the sheet thickness direction, the restriction part restricting the second sheet-shaped part from moving away from the first sheet-shaped part in the sheet thickness direction; and a welding portion that is provided in a predetermined range from the restriction part and at which the first member and the second member are welded.

### BRIEF DESCRIPTION OF THE DRAWINGS

An exemplary embodiment of the present disclosure will be described in detail based on the following figures, wherein:

FIG. 1 illustrates an image forming apparatus according to an exemplary embodiment of the present disclosure;

FIG. 2 is a perspective view of a joint structure according to the exemplary embodiment of the present disclosure;

FIG. 3 is a perspective view of a first member included in the joint structure according to the exemplary embodiment of the present disclosure;

FIG. 4 is a plan view of the first member included in the joint structure according to the exemplary embodiment of the present disclosure;

FIG. 5 is a sectional view of the first member included in the joint structure according to the exemplary embodiment of the present disclosure when viewed in the direction indicated by V-V in FIG. 4;

FIG. 6 is a plan view of a second member included in the joint structure according to the exemplary embodiment of the present disclosure;

FIG. 7 is a sectional view of the second member included in the joint structure according to the exemplary embodiment of the present disclosure when viewed in the direction indicated by VII-VII in FIG. 6;

FIG. 8 is a perspective view illustrating a state where the first member and the second member are assembled in a joining method according to the exemplary embodiment of the present disclosure;

FIG. 9 is a plan view illustrating the state where the first member and the second member are assembled in the joining method according to the exemplary embodiment of the present disclosure; and

FIG. 10 is a sectional view illustrating the state where the first member and the second member are assembled in the joining method according to the exemplary embodiment of the present disclosure when viewed in the direction indicated by X-X in FIG. 9.

### DETAILED DESCRIPTION

Hereinafter, an example of an exemplary embodiment of the present disclosure will be described with reference to the figures. Note that, in the figures, the same or equivalent constituent elements and components are denoted by the same reference signs. In addition, dimensional ratios in the figures may be exaggerated for convenience of description and may differ from the actual ratios.

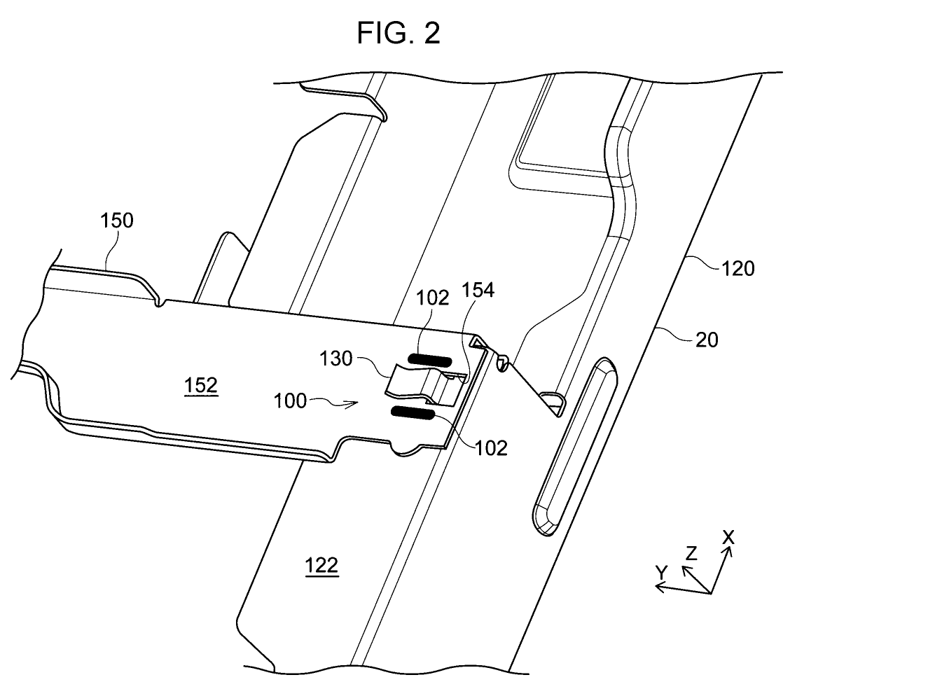

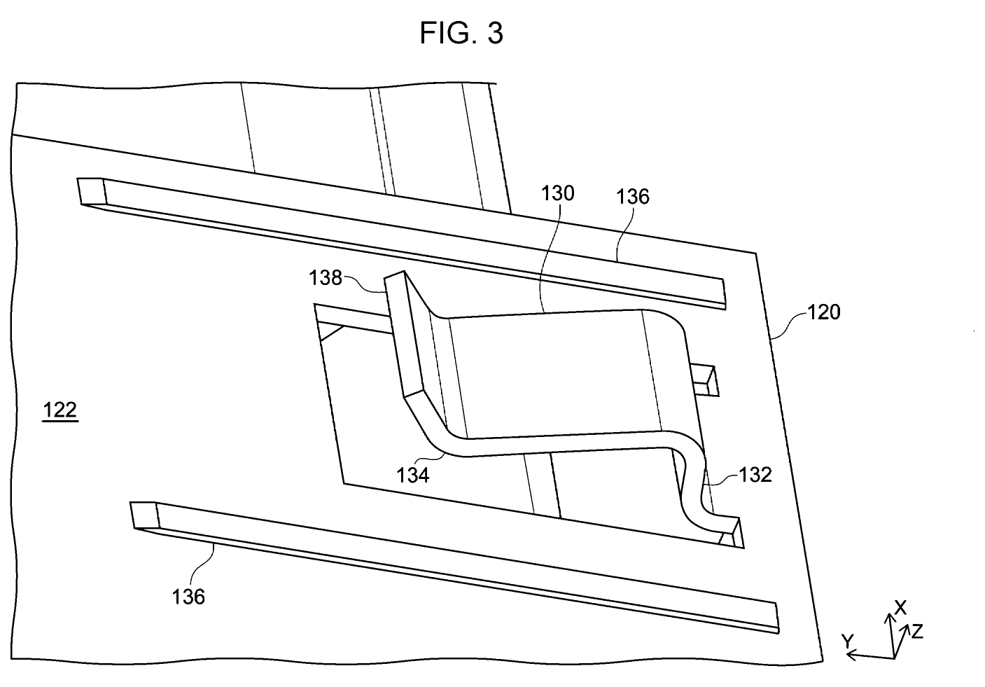

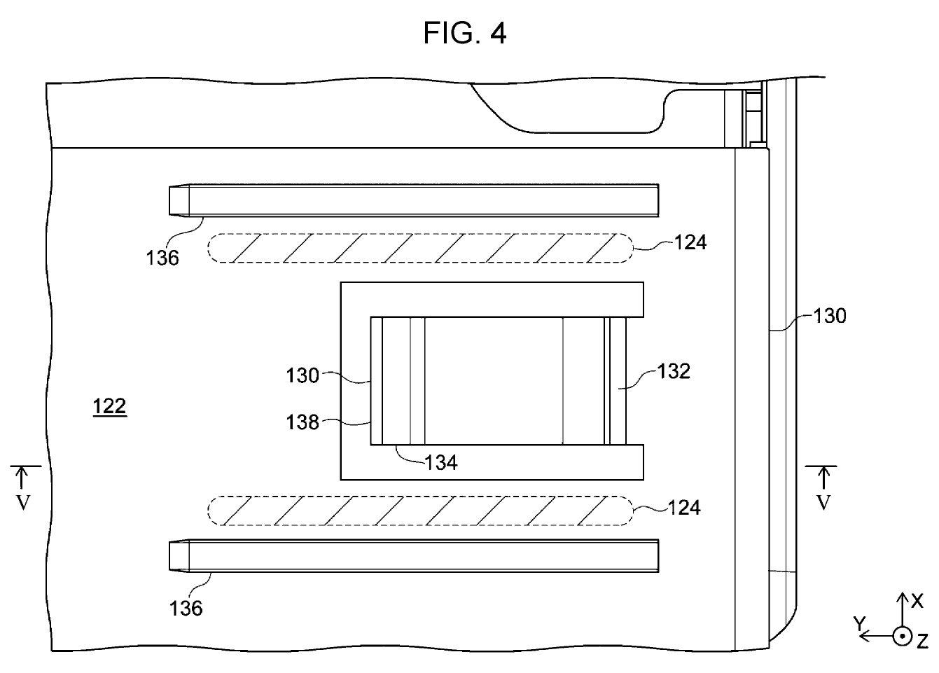

An arrow X direction, an arrow Y direction, and an arrow Z direction given in the figures indicate directions orthogonal to one another. In particular, the arrow X direction, the arrow Y direction, and the arrow Z direction given in FIGS. 3 to 10 indicate respective directions of each member included in a joint structure illustrated in FIG. 2. Note that the arrow X direction, the arrow Y direction, and the arrow Z direction may each be any direction of an image forming apparatus.

### Exemplary Embodiment

### Structure

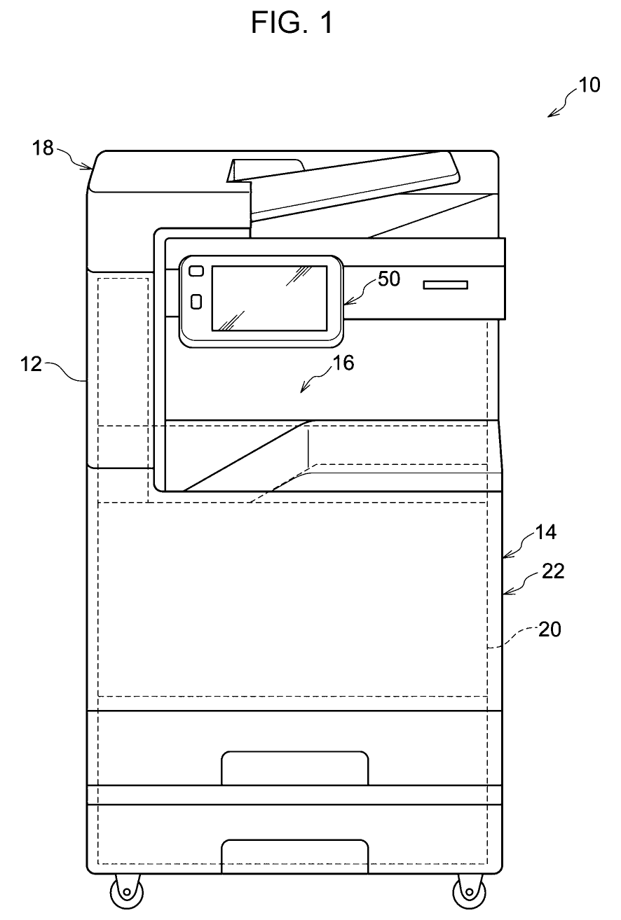

FIG. 1 illustrates an image forming apparatus 10 according to an exemplary embodiment of the present disclosure. As FIG. 1 illustrates, the image forming apparatus 10 according to the present disclosure includes an image forming unit 14, a document reading unit 18, an apparatus housing 12, and a user interface 50.

As FIG. 1 illustrates, the apparatus housing 12 includes a frame 20 and an exterior 22. The frame 20 is a member supporting each constituent of the image forming apparatus 10. As will be described later, the frame 20 is formed by joining frameworks made of metal sheet in one example. The exterior 22 is a member covering the frame 20 from outside and serving as a designed surface of the image forming apparatus 10. The exterior 22 may be made of any material not easily deform and may be a member made of an artificial resin in one example.

The image forming unit 14 is a constituent having a function of a laser printer that prints an image on recording paper by a laser system and is a device disposed on the lower side in the image forming apparatus 10 as FIG. 1 illustrates. The image forming unit 14 includes a toner image forming part, a transfer part that transfers the toner image formed at the toner image forming part onto recording paper, and a fixing device that fixes the transferred toner image to the recording paper, which are not illustrated. Each of the constituents associated with the image forming unit 14 are accommodated inside the apparatus housing 12 and controlled by a controller, which is not illustrated, based on a print job input by user input operation. The recording paper to which the toner image has been fixed by the image forming unit 14 is output outside the apparatus housing 12 from a sheet output unit 16.

As FIG. 1 illustrates, the document reading unit 18 is a device disposed on the upper side in the image forming apparatus 10. The document reading unit 18 includes an automatic document feeder (ADF) that automatically sends a document (recording paper on which an image is formed), and the document reading unit 18 has a function of reading an image formed on each document and a function of forming electronic data.

The user interface 50 is a device disposed on a front surface of the image forming apparatus 10 (on the near side of FIG. 1) and is made available for the user of the image forming apparatus 10 to use. The user interface 50 includes a touch panel in one example.

Subsequently, a joint structure 100 included in the frame 20 in the present exemplary embodiment will be described in detail with reference to FIGS. 2 to 10.

### Frame 20 and Joint Structure 100

FIG. 2 illustrates a portion of the frame 20 of the image forming apparatus 10 in the present exemplary embodiment. The frame 20 of the image forming apparatus 10 in the present exemplary embodiment includes the joint structure 100 in the present disclosure. The joint structure 100 is formed by laser-welding a first member 120 and a second member 150 to each other. More specifically, the first member 120 and the second member 150 are overlapped in a sheet thickness direction (the arrow Z direction in each figure). The joint of the joint structure 100 is achieved at welding portions 102 by laser-welding sports in a range where the first member 120 and the second member 150 are overlapped.

### First Member 120

As FIGS. 3 to 5 illustrate, the first member 120 is a member made of a metal sheet provided with a first sheet-shaped part 122 and a restriction part 130. In addition, as FIGS. 3 to 5 illustrate, the first sheet-shaped part 122 includes joint target portions 124 to be welded to the second member 150. In the present exemplary embodiment, the material of the first member 120 is set appropriately, and a galvanized steel sheet is used in one example. The galvanized steel sheet may be formed by electrogalvanizing or by hot-dip galvanizing. In addition, zinc to be plated on a steel sheet may be an alloy of zinc–aluminum–magnesium. The galvanized steel sheet is not the only option, and a steel sheet whose surface is coated may be used.

The first sheet-shaped part 122 is, in the metal sheet, a sheet surface-shaped part to be joined to the second member 150. The sheet thickness of the first sheet-shaped part 122 is set appropriately and is preferably 0.6 mm or more and less than 2.0 mm in one example.

As FIGS. 3 to 5 illustrate, the restriction part 130 is a part cut and raised on the side to be overlapped onto the second member 150, that is, toward one side in the Z arrow direction. More specifically, the restriction part 130 is a part cut and raised by cutting three sides of a substantial rectangle and by bending the remaining side in the sheet thickness direction. Note that, a portion, of the restriction part 130, connected to the first sheet-shaped part 122 is a connection portion 132 connected to a clip portion 134, which will be described later.

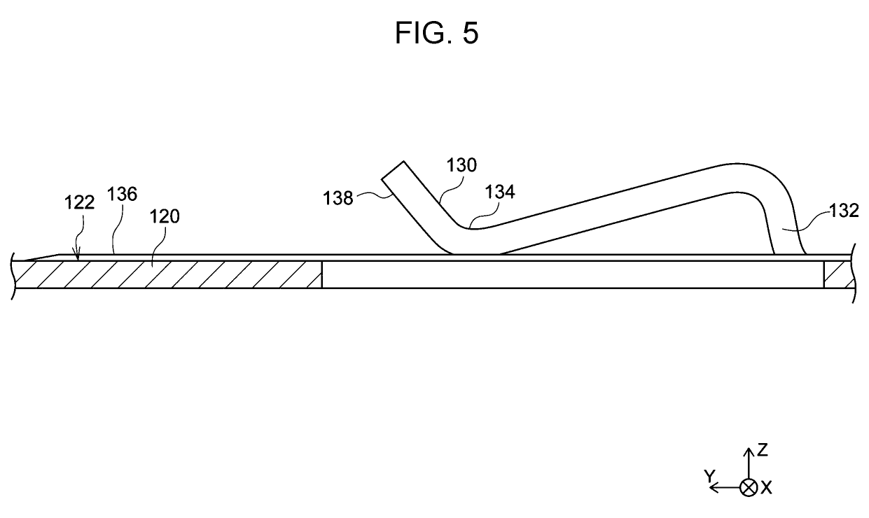

In addition, as FIGS. 3 and 5 illustrate, the restriction part 130 extends, from the connection portion 132, in a direction toward a sheet surface of the first sheet-shaped part 122. More specifically, the restriction part 130 includes the clip portion 134, and the clip portion 134 is closer to the sheet surface of the first sheet-shaped part 122 than each protrusion 136 when viewed from a section of the first sheet-shaped part 122 and holds a second sheet-shaped part 152, which will be described later, between the clip portion 134 and the first sheet-shaped part 122. In addition, as FIG. 5 illustrates, an end, of the restriction part 130, opposite from the connection portion 132 relative to the clip portion 134 serves as an insertion portion 138 that is apart from the sheet surface of the first sheet-shaped part 122 by a distance greater than the sheet thickness of the second sheet-shaped part 152, which will be described later.

As FIGS. 3 to 5 illustrate, the first sheet-shaped part 122 also includes the protrusions 136. As FIGS. 3 to 5 illustrate, the protrusions 136 protrude, on the side to be overlapped onto the second member 150, toward one side in the Z arrow direction toward which the restriction part 130 is cut and raised.

In addition, in the present exemplary embodiment, the protrusions 136 have shapes extending parallel to each other on both sides across the restriction part 130. More specifically, as FIGS. 3 to 5 illustrate, each of the protrusions 136 protrudes at a spot apart from the restriction part 130 by a predetermined interval. Note that the size by which the protrusion 136 protrudes from the sheet surface of the first sheet-shaped part 122 is set appropriately and is preferably 0.1 mm or more and less than 0.4 mm in one example.

As will be described later, in the present exemplary embodiment, portions of the first sheet-shaped part 122 between the restriction part 130 and the protrusions 136 serve as the joint target portions 124 to be joined to the second member 150. More specifically, each of the joint target portions 124 is provided in a predetermined range from the restriction part 130. Note that the "predetermined range" will be described later.

Note that there is no particular limitation in the shape of a portion of the first sheet-shaped part 122 except the restriction part 130 and the joint target portions 124 to be joined to the second member 150. For example, as FIGS. 2 to 5 illustrate, a portion of the first member 120 different from the first sheet-shaped part 122 may be subjected to another processing (such as bending, drawing, and punching).

### Second Member 150

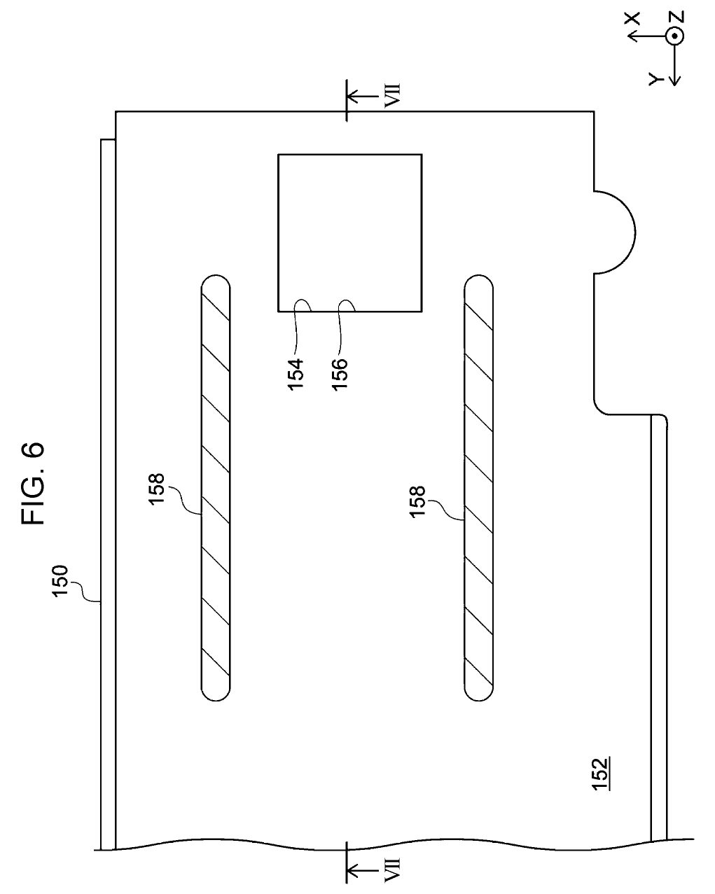

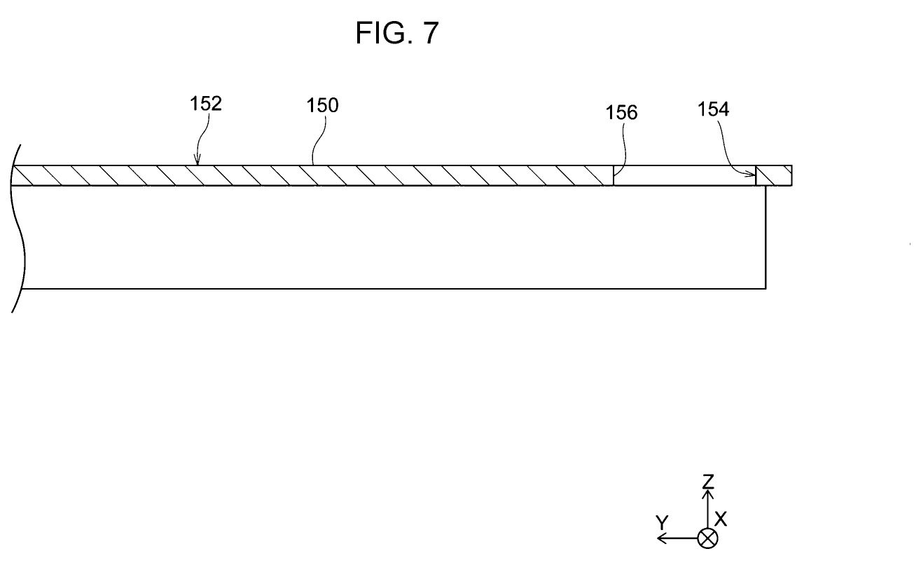

As FIGS. 6 and 7 illustrate, the second member 150 is a member made of a metal sheet including the second sheet-shaped part 152. In addition, as FIGS. 6 and 7 illustrate, the second sheet-shaped part 152 includes joint target portions 158 to be welded to the first member 120. In the present exemplary embodiment, the material of the second member 150 is set appropriately, and a galvanized steel sheet similar to the first member 120 is used in one example.

The second sheet-shaped part 152 is, in the steel sheet, a sheet surface-shaped part to be joined to the first member 120. The sheet thickness of the second sheet-shaped part 152 is set appropriately and is preferably 0.6 mm or more and less than 2.0 mm in one example.

In addition, as FIGS. 6 and 7 illustrate, a hole 154 opened in the sheet thickness direction is formed in the second sheet-shaped part 152. The hole 154 has a size allowing insertion and passage of the restriction part 130 included in the first member 120. Note that the width of the hole 154 is narrower than the interval between the two protrusions 136.

As will be described later, in the present exemplary embodiment, both sides of the second sheet-shaped part 152 across the hole 154 serve as the joint target portions 158 to be joined to the first member 120. More specifically, each of the joint target portions 158 is provided in a predetermined range from the hole 154.

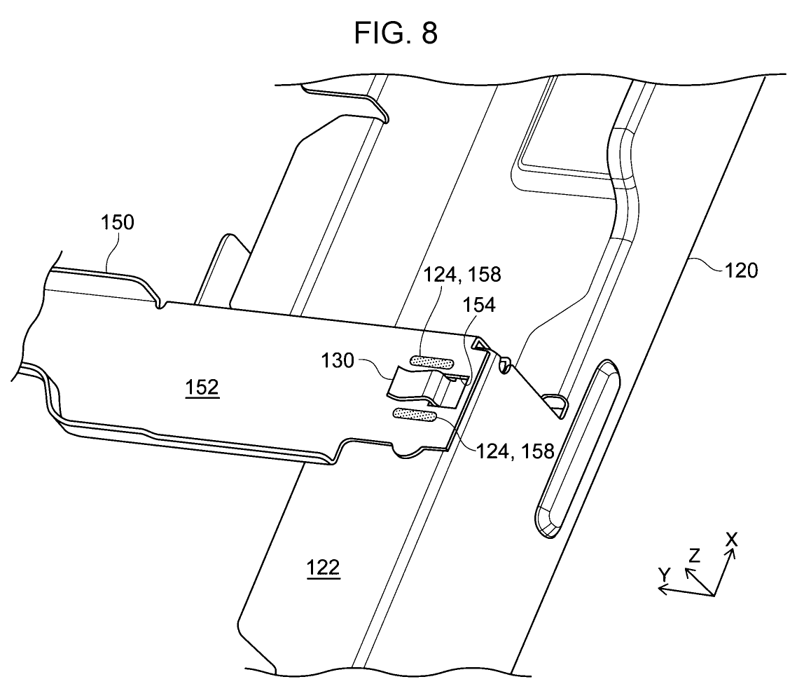

Note that the "predetermined range" in which the joint target portions 124 of the first sheet-shaped part 122 and the joint target portions 158 of the second sheet-shaped part 152 are each provided refers to a region in which, with the restriction part 130, the first sheet-shaped part 122 and the second sheet-shaped part 152 are placed close enough to be welded together. That is, as in FIGS. 8 to 10, which will be described later, the "predetermined range" may be a region in which laser welding can be performed when the first sheet-shaped part 122 and the second sheet-shaped part 152 are joined. For example, the "predetermined range" is a region, within a radius of 50 mm from the clip portion 134, in which the first sheet-shaped part 122 and the second sheet-shaped part 152 overlap each other, and the "predetermined range" is a region, preferably within a radius of 30 mm from the clip portion 134, more preferably within a radius of 10 mm from the clip portion 134, in which the first sheet-shaped part 122 and the second sheet-shaped part 152 overlap each other. In addition, for example, as will be described later, the "predetermined range" is a range in which a clearance 160 between the first sheet-shaped part 122 and the second sheet-shaped part 152 that are overlapped with one another is 0.10 mm or more and less than 0.30 mm, and the "predetermined range" is a range in which the clearance 160 is preferably 0.15 mm or more and less than 0.25 mm, more preferably 0.18 mm or more and less than 0.22 mm.

Subsequently, a joining method in the present exemplary embodiment will be described with reference to FIGS. 8 to 10.

### Joining Method and Temporary Fixation

FIG. 8 illustrates a state where the first member 120 and the second member 150 are temporarily fixed, as the joining method in the present exemplary embodiment. In the joining method in the present exemplary embodiment, first, the restriction part 130 of the first member 120 is inserted through the hole 154 of the second member 150. Then, the second sheet-shaped part 152 of the second member 150 is inserted to the restriction part 130 of the first member 120 from the insertion portion 138 of the restriction part 130 so as to open the clip portion 134.

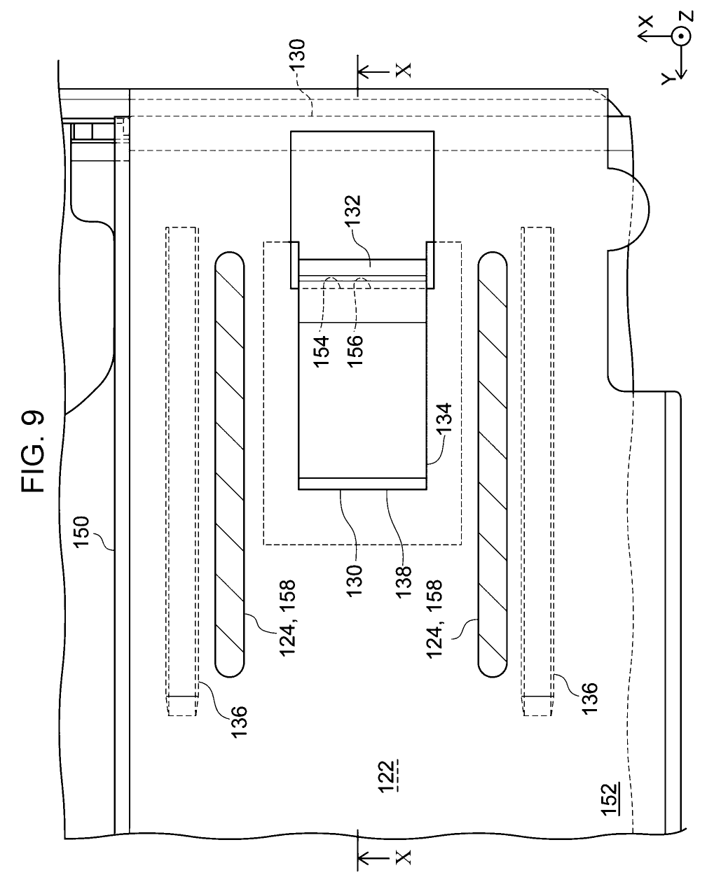

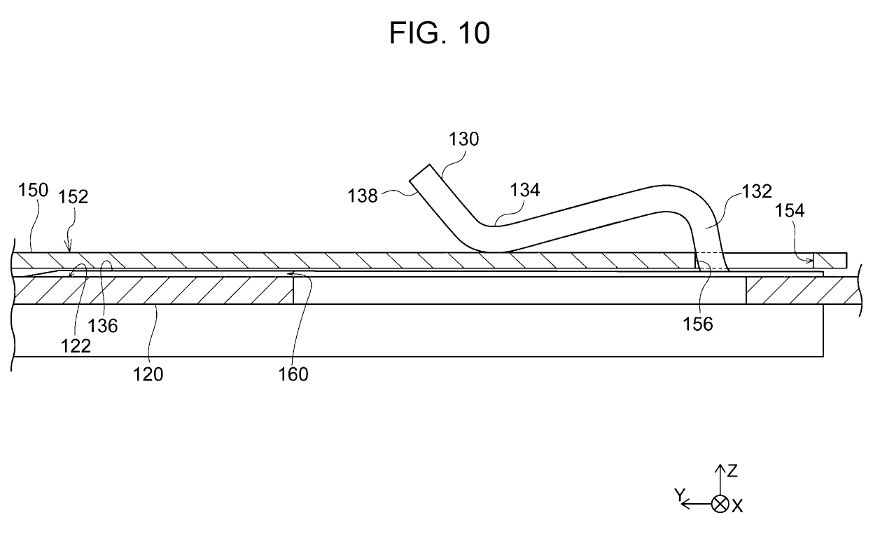

Here, as FIGS. 9 and 10 illustrate, the restriction part 130 that has been passed through the hole 154 of the second member 150 comes into contact with a sheet surface of the second sheet-shaped part 152. More specifically, the clip portion 134 included in the restriction part 130, while coming into contact with the sheet surface of the second sheet-shaped part 152, presses the second sheet-shaped part 152 toward the first sheet-shaped part 122. Thus, as FIGS. 8 to 10 illustrate, the second member 150 is restricted from moving away from the first member 120 in the sheet thickness direction, that is, in the arrow Z direction. That is, the state illustrated in FIGS. 8 to 10 is a temporarily fixed state where the first member 120 and the second member 150 are temporarily restricted from moving away from each other. Note that, in the present disclosure, "joining" includes such a temporarily fixed state where the first member 120 and the second member 150 are temporarily restricted from moving away from each other.

In addition, as FIG. 10 illustrates, the first member 120 includes the protrusions 136 in the present exemplary embodiment. Thus, the second sheet-shaped part 152 is temporarily fixed at a position apart from the sheet surface of the first sheet-shaped part 122 by a distance equivalent to the height of the protrusion 136. In other words, the first sheet-shaped part 122 is temporarily fixed to the second sheet-shaped part 152 with the clearance 160 therebetween.

In addition, in the joining method in the present exemplary embodiment, as FIG. 10 illustrates, an end surface 156 defining the hole 154 of the second member 150 is caused to abut against the connection portion 132 provided for the restriction part 130. Thus, in the present exemplary embodiment, the second member 150 is positioned relative to the first member 120 by the abutting of the end surface 156 of the hole 154 of the second member 150 against the connection portion 132. In other words, the second member 150, while being positioned relative to the first member 120, is temporarily fixed to the first member 120.

In addition, in the present exemplary embodiment, the joint target portions 124 and the respective joint target portions 158 are welded, with the first member 120 and the second member 150 being temporarily fixed. Specifically, as FIGS. 8 to 10 illustrate, in the temporarily fixed state, the joint target portions 124 of the first member 120 overlap the respective joint target portions 158 of the second member 150 in the sheet thickness direction. Then, a laser light is made incident to the second member 150 to weld the first member 120 and the second member 150 together through laser welding. Thus, the first member 120 and the second member 150 are joined into the joint structure 100 illustrated in FIG. 2.

The joint structure 100, the image forming apparatus 10, and the joining method according to the present exemplary embodiment act as follows.

### Actions

Relative to a direction where the first sheet-shaped part 122 of the first member 120 extends, the joint structure 100 according to this aspect includes the restriction part 130 restricting movement in the sheet thickness direction. In addition, in the temporarily fixed state, with the restriction part 130, the second sheet-shaped part 152 in the second member 150 is restricted from moving away in the sheet thickness direction. The second sheet-shaped part 152 is welded to the first sheet-shaped part 122 in the predetermined range from the restriction part 130.

Thus, with the joint structure 100 according to this aspect, a welding operation may be performed with the second member 150 being temporarily fixed by the restriction part 130. In other words, the joint structure 100 according to this aspect may facilitate a process in manufacturing, compared with a structure in which joining is achieved with only the welding portions 102.

In addition, in the joint structure 100 according to this aspect, the restriction part 130 presses the second sheet-shaped part 152 of the second member 150 toward the first sheet-shaped part 122. Thus, with the joint structure 100 according to this aspect, the second member 150 is hardly misaligned relative to the first member 120. In other words, the joint structure 100 according to this aspect may improve the joint quality of welding, compared with a case where the restriction part 130 only catches the second sheet-shaped part 152.

In addition, in the joint structure 100 according to this aspect, the end surface 156 of the second sheet-shaped part 152 of the second member 150 is caused to abut against the connection portion 132 of the restriction part 130. Thus, with the joint structure 100 according to this aspect, the second member 150 may be positioned relative to the first member 120 by the restriction part 130. In other words, the joint structure 100 according to this aspect may improve the dimensional accuracy of welding, compared with a case where the second sheet-shaped part 152 of the second member 150 is apart from the restriction part 130.

In addition, in the joint structure 100 according to this aspect, the restriction part 130 is inserted through the hole 154 made in the second sheet-shaped part 152 of the second member 150. With the joint structure 100 according to this aspect, the restriction part 130 gets caught in the hole 154 and thereby hardly come out of the hole 154. Thus, the joint structure 100 according to this aspect may facilitate a welding operation, compared with a case where the restriction part 130 is not inserted through the hole 154.

In addition, in the joint structure 100 according to this aspect, the first member 120 includes the protrusions 136 protruding on the side to be overlapped in the sheet thickness direction. Thus, with the joint structure 100 according to this aspect, the clearance 160 may be formed between the second sheet-shaped part 152 and the first sheet-shaped part 122. The joint structure 100 according to this aspect may facilitate, from the clearance 160, removal of a gas containing impurities that cause a joint failure of welding. For example, when the first member 120 and the second member 150 are each a galvanized steel sheet, the joint structure 100 according to this aspect may facilitate, from the clearance 160, discharge of vapor of zinc that vaporizes due to the heat of welding.

Thus, the joint structure 100 according to this aspect may facilitate the welding of the first sheet-shaped part 122 and the second sheet-shaped part 152. In other words, the joint structure 100 according to this aspect may improve the joint quality of the welding portion 102, compared with a case where the first sheet-shaped part 122 of the first member 120 and the second sheet-shaped part 152 of the second member 150 are overlapped at flat spots thereof.

In addition, in the joint structure 100 according to this aspect, the welding between the first sheet-shaped part 122 and the second sheet-shaped part 152 is achieved with the welding portions 102 between the restriction part 130 and the protrusions 136. Thus, with the joint structure 100 according to this aspect, the second member 150 is temporarily fixed by the protrusions 136 and the restriction part 130. Accordingly, the joint structure 100 according to this aspect may improve the joint quality of the welding portions 102, compared with a case where the welding portions 102 are positioned outside the regions between the protrusions 136 and the restriction part 130.

In addition, in the joint structure 100 according to this aspect, the welding between the first sheet-shaped part 122 and the second sheet-shaped part 152 is achieved with the welding portions 102 between the two the protrusions 136. Thus, with the joint structure 100 according to this aspect, the two protrusions 136 may facilitate determination of the interval of the clearance 160 between the first sheet-shaped part 122 and the second sheet-shaped part 152. In other words, the joint structure 100 according to this aspect may improve the joint quality of the welding portions 102, compared with a case where the welding portions 102 are positioned outside the region between the two protrusions 136.

In addition, the image forming apparatus 10 according to this aspect may facilitate a process in manufacturing, compared with an apparatus in which the joining of the frame 20 is achieved with only the welding portions 102.

In addition, the joining method according to this aspect includes preparing the first member provided with the restriction part 130 disposed apart from the first sheet-shaped part 122, and restricting, with the restriction part 130, the second sheet-shaped part 152 of the second member 150 from moving away in the sheet thickness direction. Then, in the first member 120 and the second member 150, the second sheet-shaped part 152 is welded to the first sheet-shaped part 122 in the predetermined range from the restriction part 130.

Thus, with the joining method according to this aspect, a welding operation may be performed with the second member 150 being temporarily fixed to the first member 120 with the restriction part 130. In other words, the joining method according to this aspect may facilitate a welding operation in manufacturing, compared with a method in which joining is achieved with only the welding portions 102.

### Modifications

Note that, although a joint part is between the restriction part 130 and the protrusion 136 in the above description, the joining method in the present disclosure is not limited thereto. The joint part may be any region where laser welding can be performed when the first sheet-shaped part 122 and the second sheet-shaped part 152 are joined as described above. That is, the joint target portion 124 included in the first sheet-shaped part 122 and the joint target portion 158 included in the second sheet-shaped part 152 may each be on the opposite side from the restriction part 130 relative to the protrusion 136. The joint target portion 124 included in the first sheet-shaped part 122 and the joint target portion 158 included in the second sheet-shaped part 152 may each be provided ahead in a direction where the restriction part 130 extends.

In addition, although the first sheet-shaped part 122 includes the protrusions 136 protruding in a direction where the first sheet-shaped part 122 comes into contact with the second sheet-shaped part 152, the joining method in the present disclosure is not limited thereto. For example, the second sheet-shaped part 152 may include a protrusion 136 protruding in a direction where the second sheet-shaped part 152 comes into contact with the first sheet-shaped part 122.

In addition, for example, a constituent for forming the clearance 160 between the first sheet-shaped part 122 and the second sheet-shaped part 152 with the first member 120 and the second member 150 being temporarily fixed is not limited to the protrusion 136. Another member (for example, a material such as a strip of paper that is thin and has no influence on the quality of welding) having a height similar to the height of the above-described protrusion 136 may be provided between the first sheet-shaped part 122 and the second sheet-shaped part 152. That is, a constituent for forming the clearance 160 is not limited to the protrusion 136 as long as the clearance 160 can be formed with the constituent with the first member 120 and the second member 150 being temporarily fixed.

In addition, although the hole 154 is made in the second sheet-shaped part 152 in the above description, the joining method in the present disclosure is not limited thereto. For example, a temporary fixation aspect of the first member 120 and the second member 150 may be achieved by inserting an end surface 156 of the sheet surface of the second sheet-shaped part 152 to the restriction part 130 of the first member 120.

In addition, the second member 150 is positioned by causing the end surface 156 of the second sheet-shaped part 152 to abut against the connection portion 132 of the first member 120 in the above description. The joining method in the present disclosure is not limited thereto, and the end surface 156 of the second sheet-shaped part 152 is not necessarily caused to abut against the connection portion 132 of the first member 120 as long as the first member 120 and the second member 150 can be temporarily fixed.

For example, a positioning aspect of the first member 120 and the second member 150 may be achieved by providing a recess, in the second sheet-shaped part 152, in which the clip portion 134 of the restriction part 130 gets caught and by fitting the clip portion 134 in the recess. In addition, instead of the recess, a hole 154 extending through the second sheet-shaped part 152 in the sheet thickness direction may be possible. In other words, an aspect in which the restriction part 130 does not press the second sheet-shaped part 152 toward the first sheet-shaped part 122 may be possible as long as the first member 120 and the second member 150 can be temporarily fixed by the restriction part 130.

The modifications also act as in the above description.

The exemplary embodiment of the present disclosure has so far been described with reference to the accompanying drawings; however, various modifications or applications will be apparent to practitioners skilled in the art to which the present disclosure belongs, within the range of the technical idea described in claims, and it is to be understood that the technical scope of the present disclosure encompasses the modifications and applications.

### Appendix

### (((1)))

A joint structure comprising:

a first member including a first sheet-shaped part;

a second member including a second sheet-shaped part overlapped with the first sheet-shaped part in a sheet thickness direction of the first sheet-shaped part and the second sheet-shaped part;

a restriction part provided for the first member, the restriction part being in contact with the second member from an opposite side from the first sheet-shaped part side relative to the second sheet-shaped part in the sheet thickness direction, the restriction part restricting the second sheet-shaped part from moving away from the first sheet-shaped part in the sheet thickness direction; and

a welding portion that is provided in a predetermined range from the restriction part and at which the first member and the second member are welded.

### (((2)))

The joint structure according to (((1))), wherein:

the restriction part presses the second sheet-shaped part of the second member toward the first sheet-shaped part.

### (((3)))

The joint structure according to (((2))), further comprising:

a connection portion connecting the first member and the restriction part to each other, wherein:

the second sheet-shaped part of the second member is positioned by causing an end surface of the second sheet-shaped part to abut against the connection portion.

### (((4)))

The joint structure according to any one of (((1))) to (((3))), wherein:

the restriction part is passed through a hole made in the second sheet-shaped part of the second member.

### (((5)))

The joint structure according to any one of (((1))) to (((4))), wherein:

the first member or the second member incudes, in a range where the first sheet-shaped part and the second sheet-shaped part are overlapped, a protrusion protruding on a side to be overlapped in the sheet thickness direction.

### (((6)))

The joint structure according to (((5))), wherein:

the welding portion is provided between the restriction part and the protrusion.

### (((7)))

An image forming apparatus comprising:

a frame including the joint structure according to any one of (((1))) to (((6))); and

an image recording unit supported by the frame and configured to form an image on a recording medium.

### (((8)))

A joining method comprising:

preparing a first member provided with a first sheet-shaped part and a restriction part disposed apart from the first sheet-shaped part in a sheet thickness direction;

restricting, with the restriction part, a second sheet-shaped part of a second member from moving away from the first sheet-shaped part of the first member in the sheet thickness direction; and

welding the first sheet-shaped part and the second sheet-shaped part by performing irradiation of a laser light in a predetermined range, of the second sheet-shaped part, from the restriction part.

What is claimed is:

1. A joint structure comprising:
a first member including a first sheet-shaped part;
a second member including a second sheet-shaped part overlapped with the first sheet-shaped part in a sheet thickness direction of the first sheet-shaped part and the second sheet-shaped part;
a restriction part provided for the first member, the restriction part being in contact with the second member from an opposite side from the first sheet-shaped part side relative to the second sheet-shaped part in the sheet thickness direction, the restriction part restricting the second sheet-shaped part from moving away from the first sheet-shaped part in the sheet thickness direction; and
a welding portion that is provided in a predetermined range from the restriction part and at which the first member and the second member are welded.

2. The joint structure according to claim 1, wherein:
the restriction part presses the second sheet-shaped part of the second member toward the first sheet-shaped part.

3. The joint structure according to claim 2, further comprising:
a connection portion connecting the first member and the restriction part to each other, wherein:
the second sheet-shaped part of the second member is positioned by causing an end surface of the second sheet-shaped part to abut against the connection portion.

4. The joint structure according to claim 1, wherein:
the restriction part is passed through a hole made in the second sheet-shaped part of the second member.

5. The joint structure according to claim 2, wherein:
the restriction part is passed through a hole made in the second sheet-shaped part of the second member.

6. The joint structure according to claim 3, wherein:
the restriction part is passed through a hole made in the second sheet-shaped part of the second member.

7. The joint structure according to claim 1, wherein:
the first member or the second member incudes, in a range where the first sheet-shaped part and the second sheet-shaped part are overlapped, a protrusion protruding on a side to be overlapped in the sheet thickness direction.

8. The joint structure according to claim 7, wherein:
the welding portion is provided between the restriction part and the protrusion.

9. An image forming apparatus comprising:
a frame including the joint structure according to claim 1; and
an image recording unit supported by the frame and configured to form an image on a recording medium.

10. An image forming apparatus comprising:
a frame including the joint structure according to claim 2; and
an image recording unit supported by the frame and configured to form an image on a recording medium.

11. An image forming apparatus comprising:
a frame including the joint structure according to claim 3; and
an image recording unit supported by the frame and configured to form an image on a recording medium.

12. An image forming apparatus comprising:
a frame including the joint structure according to claim 4; and
an image recording unit supported by the frame and configured to form an image on a recording medium.

13. An image forming apparatus comprising:
a frame including the joint structure according to claim 5; and
an image recording unit supported by the frame and configured to form an image on a recording medium.

14. An image forming apparatus comprising:
a frame including the joint structure according to claim 6; and
an image recording unit supported by the frame and configured to form an image on a recording medium.

15. An image forming apparatus comprising:
a frame including the joint structure according to claim 7; and
an image recording unit supported by the frame and configured to form an image on a recording medium.

16. An image forming apparatus comprising:
a frame including the joint structure according to claim 8; and
an image recording unit supported by the frame and configured to form an image on a recording medium.

17. A joining method comprising:
preparing a first member provided with a first sheet-shaped part and a restriction part disposed apart from the first sheet-shaped part in a sheet thickness direction;
restricting, with the restriction part, a second sheet-shaped part of a second member from moving away from the first sheet-shaped part of the first member in the sheet thickness direction; and
welding the first sheet-shaped part and the second sheet-shaped part by performing irradiation of a laser light in a predetermined range, of the second sheet-shaped part, from the restriction part.
